(19) United States
(12) Patent Application Publication
(10) Pub. No.: US 2006/0114828 A1
(43) Pub. Date: Jun. 1, 2006

(54) Data transmission ports with flow controlling unit and method for performing the same

(75) Inventor: R-Ming Hsu, Hsinchu County (TW)

Correspondence Address: TROXELL LAW OFFICE PLLC, SUITE 1404, 5205 LEESBURG PIKE, FALLS CHURCH, VA, 22041, US

(73) Assignee: Silicon Integrated System Corp.

(21) Appl. No.: 11/000,026

(22) Filed: Dec. 1, 2004

(51) Int. Cl. H04J 1/16

(52) U.S. Cl. 370/235

(57) ABSTRACT

The present invention discloses reconfigurable data transmission ports with flow controlling unit in a computerized computer and the method for performing the same. When a specific first port is configured on “merge” status, a buffer-configuration subunit of the flow controlling unit can compliantly configure a receiving buffer owned by the specific first port and at least one receiving buffer owned but disused by the other first port to constitute a buffer group with merging of storing spaces of said configured receiving buffers. A credit message covering empty part of the merged storing space of the buffer group is reported from the specific first port to a credit tracker of a correspond second port thereby determining whether a data is send from the second port to be stored within the buffer group for data consumption of the specific first port from the buffer group. Hence, the present invention is capable of providing a optimum and flexible flow-control service during data transaction, without need of enlarging receiving buffer, in compliance with requirement of different configuration status of data-transmission port with variance of bandwidth.

### BACKGROUND OF INVENTION

1. Field of the Invention

The present invention relates to data transmission ports of a computerized system and more particularly in reconfigurable data transmission ports with a flow controlling unit and method for performing the same, which provide an optimum flow control service during data transaction.

2. Description of the Prior Art

As known, recently a re-configurable transmission port technology is being widely utilized in input/output ports of a computerized system, which are respectively connected with I/O buses, e.g. a PCI Express. Conception of such re-configurable transmission port means that a data transmission port is capable of being reconfigured into either a “split” status as illustrated in FIG. 1 or a “merge” status as illustrated in FIG. 2, by way of implementation of a presetting software or an auto-detection for different bandwidth requirements.

Referring to FIG. 1A, a plurality of first and second ports 10, 14 in a computerized system respectively implement data transaction with each other via a physical layer (PHY) 12 and a transmission line 13. As soon as each of the first ports 10 are configured on the “split” status (“x 1” means “one port” and “x N” means “N ports”), the plurality of first ports 10 are divided into “N” first ports each with lower individual bandwidth respectively connected to N second ports. Oppositely referring to FIG. 1B, as soon as some/all of the first ports 10, e.g. first ports 1˜N, are configured on the “merge” status, one of the first ports 10, e.g. first port 1, is merged with multi-bandwidths of the other first ports 10, e.g. first ports 2˜N, and controls transmission lines and PHY 12 of the other first ports 10. The merged bandwidth of the first port I shown in FIG. 1B is higher than individual bandwidth of each first ports 2˜N configured on split status shown in FIG. 1A and therefore capable of transmitting more data. Hence, each of the first ports can be reconfigured with variance of bandwidth upon different data transmission requirement. This functions as more flexibility on data transaction via different PHY 12 and fixed transmission line 13. Further referring to FIG. 2, a data transaction between each pair of first and second ports 10, 14 is presented. Meanwhile, each of the first ports 10, e.g. port 1, has a protocol circuit 100, a credit reporter 110 and a first receiving buffer (RB) 120 disposed thereon. The protocol circuit 100 is used to control and coordinate the credit reporter 110, the first receiving buffer 120, PHY 12 and transmission line 13. The credit reporter 110 functions as periodically receiving a credit message covering empty part of a storing space of the first receiving buffer 120 (the step is referred to a numeral P126 illustrated in FIG. 2) and then periodically reporting the credit message to the remote second port 14 (the step is referred to a numeral P128 illustrated in FIG. 2). Generally speaking, storing more data will relatively decrease more credit and consuming more data will relatively increase more credit in each first receiving buffer. After the remote second port 14 receives said credit message of the first receiving buffer 120 from the first port 10, a credit tracker 142 will determine whether the credit of the first receiving buffer 120 of the first port 10 is enough to accommodates a data thereon that the second port would like to send or not. It means that the credit tracker 142 needs to determine whether the credit of the first receiving buffer 120 of the first port 10 is larger than size of the data the second port would like to send or not. As long as finding this matter that the credit is larger than size of the data, the credit tracker 142 will inform a second receiving buffer 144 owned by the second port 14 (the step is referred to a numeral P146 illustrated in FIG. 2) of sending the data stored within the second receiving buffer 144 to the first receiving buffer 120 of the first port 10 (the step is referred to a numeral P138 illustrated in FIG. 2). Thereafter, the credit recorded in the credit tracker 142 of the second port 14 is newly updated with subtraction of size of the data that was send to the first port 10, and therefore is continuously tracked for comparison with size of the next data even lacking receipt of a current credit report in time. In contract, as long as finding that the credit is less than size of the data, the credit tracker 142 will temporarily disable sending of the data from the second receiving buffer 144 to the first port 10 until a next credit is larger than size of the data. After the data is serially stored within the first receiving buffer 120, the first port 10 can further consume the data from the first receiving buffer 120. Hence, a receiving buffer with smaller storing space or a credit report with a longer period/cycle possibly causes data transaction in a throttling problem.

Additionally, on “merge” configuration status as shown in FIG. 1B, the protocol circuit 100 of a first port 10 as first port 1 with merged bandwidths just utilizes the receiving buffer owned by itself and controls the physical layers (PHY) 12 and transmission lines 13 of the other first ports 2˜N but the protocol circuit 100 and receiving buffer 110 of each of said other first ports 2˜N would be completely disused so resulting in both storing-space and cost wastes.

As theory, sufficient volume of a receiving buffer has a direct ration with respect to either bandwidth of a data transmission port or a credit report period added to a response time. While required bandwidth is increased, a common solution of either enlarging receiving buffer volume or shortening the credit report period is provided to avoid throttling. However, shortening the credit report period still has an extreme limitation. Even though a first port reports the current credit to the corresponding second port right away after consuming the data stored within the receiving buffer owned by the first port, it still needs to take a little fixed time to implement internal data process and external data transmission. And, a larger credit messages would be occupy more bandwidths between data transaction. At present, enlarging the storing space of a receiving buffer is deemed to be only one solution to avoid throttling upon multiple increases of the bandwidths. Therefore, a first port 30 shown in FIG. 3A utilizes an enlarged receiving buffer 312 disposed thereon, instead of a commonreceiving buffer 310 with a smaller space used in the other first ports 30. On “merge” configuration status as shown in FIG. 3B, the volume of the enlarged receiving buffer 312 is enough to comply with requirement of a merged multi-bandwidth. However, as long as the first port 30 returns to the “split” configuration status shown in FIG. 3A, the enlarged receiving buffer 312 would become useless and waste more hardware cost.

### SUMMARY OF INVENTION

To solve aforementioned problems, it is therefore a primary objective of the present invention to provide re-configurable data transmission ports with flow controlling unit and method for performing the same, which is capable of reconfiguring a receiving buffer owned by a specific data transmission port and some receiving buffers owned but disused by other data transmission ports into a buffer group with merging of storing spaces of said reconfigured receiving buffers upon the specific data transmission port are configured with merging of multi bandwidths of said other data transmission ports. By way of a buffer group reconfigurable with several receiving buffers disused by the merged-bandwidth first ports, the merged storing space of all of the receiving buffers of the buffer group is capable of providing a optimum and flexible flow-control service during data transaction, without need of enlarging receiving buffer with hardware-cost increase, in compliance with requirement of different configuration status of data-transmission port with variance of bandwidth.

To obtain aforementioned objective, the present invention discloses re-configurable data transmission ports with flow controlling unit. The flow controlling unit further includes a port-configuration detecting mechanism and a buffer-configuration subunit. The port-configuration detecting mechanism can inspect configuration status of all of the first ports on variance of data transmission bandwidths, e.g. “merge” or “spilt” status. The buffer-configuration subunit, upon different configuration status of each first port, functions as configuring each corresponding receiving buffer. When a specific first port on “merge” status with merging of multiple bandwidths of the other first ports, the buffer-configuration subunit can reconfigure the receiving buffer owned by the specific first port and the receiving buffers owned but disused by the other first ports to constitute a buffer group with merging of storing spaces of the configured receiving buffers. The buffer-configuration subunit further enacts a credit reporter disposed within the specific first port to report a credit covering empty part of a merged storing spaces of the buffer group to a remote second port thereby determining whether a data is relatively sent from the second port to the specific first port as soon as the credit is larger than size of the data. The data sent to the specific first port is stored within the merged storing space of buffer group used by the specific first port. Furthermore, the buffer-configuration subunit further enacts the specific first port to consume the data from the merged storing space of the buffer group.

Furthermore, the present invention further discloses a method for performing an optimum flow control between a plurality of first and second ports of a computerized system, which comprises the following steps:

detecting configuration status of the first ports with variance of data-transmission bandwidths;

determining configuration of each of the receiving buffers based on different configuration status of the first ports;

reconfiguring a main receiving buffer owned by a specific first port with merged multi-bandwidths of the other first port and at least one receiving buffer owned but disused by the other first port to constitute a buffer group with merged storing space;

enacting the first port with merged multi-bandwidths to consume a first data from the merged storing space of said buffer group;

reporting a credit covering empty part of all of the merged storing space of said buffer group to the corresponding second port;

determining whether the credit is larger than size of a second data that the second port would like to send or not;

sending the second data from the second port to the merged storing space of said buffer group as long as the credit is larger than size of the second data; and disabling sending of the second data form second port to the buffer group as long as the credit is less than size of the second data.

### BRIEF DESCRIPTION OF DRAWINGS

FIG. 1A illustrates a schematic diagram of data transaction between a plurality of first and second data transmission ports of a computerized system according to the prior art, presenting configuration of each first port on “split” status;

FIG. 1B illustrates a schematic diagram of data transaction between the plurality of first and second data transmission ports according to illustration of FIG. 1A, presenting reconfiguration of some of the first ports on “merge” status;

FIG. 2 illustrates a schematic structural diagram of each first port according to FIGS. 1A & 1B;

FIG. 3A illustrates a schematic diagram of data transaction between a plurality of first and second data transmission ports of a computerized system according to the prior art, presenting a “split” configuration status of one first port disposed with an enlarged receiving buffer;

FIG. 3B illustrates a schematic diagram of data transaction between a plurality of first and second data transmission ports of a computerized system according to the prior art, presenting a “merge” configuration status of the first port disposed with enlarged receiving buffer, with merging of multi-bandwidths of all of the other first ports;

FIG. 4A illustrates a schematic diagram of data transaction between a plurality of first and second data transmission ports of a computerized system according to a first preferred embodiment of the present invention, presenting a “spilt” configuration status of each first port disposed with a controlling unit;

FIG. 4B illustrates a schematic diagram of data transaction between a plurality of first and second data transmission ports of a computerized system according to the first preferred embodiment of the present invention, presenting a “merge” configuration status of all of the first ports disposed with controlling units;

FIG. 5 illustrates a schematic structural diagram of a first port according to the first preferred embodiment of the present invention;

FIG. 6 illustrates a schematic diagram of data transaction between a plurality of first and second data transmission ports of a computerized system according to a second preferred embodiment of the present invention, presenting reconfiguration of some of the first ports disposed with controlling units on “merge” status;

FIG. 7 illustrates a schematic diagram of data transaction between a plurality of first and second data transmission ports of a computerized system according to a third preferred embodiment of the present invention, presenting a controlling unit disposed out of the first ports with “merge” configuration status;

FIG. 8 illustrates a schematic diagram of data transaction between a plurality of first and second data transmission ports of a computerized system according to a fourth preferred embodiment of the present invention, presenting that the second port respectively sends several data to each of the first ports with “merge” configuration status; and

FIGS. 9 & 10 illustrate a method according to the present invention, performing flow-control data transaction.

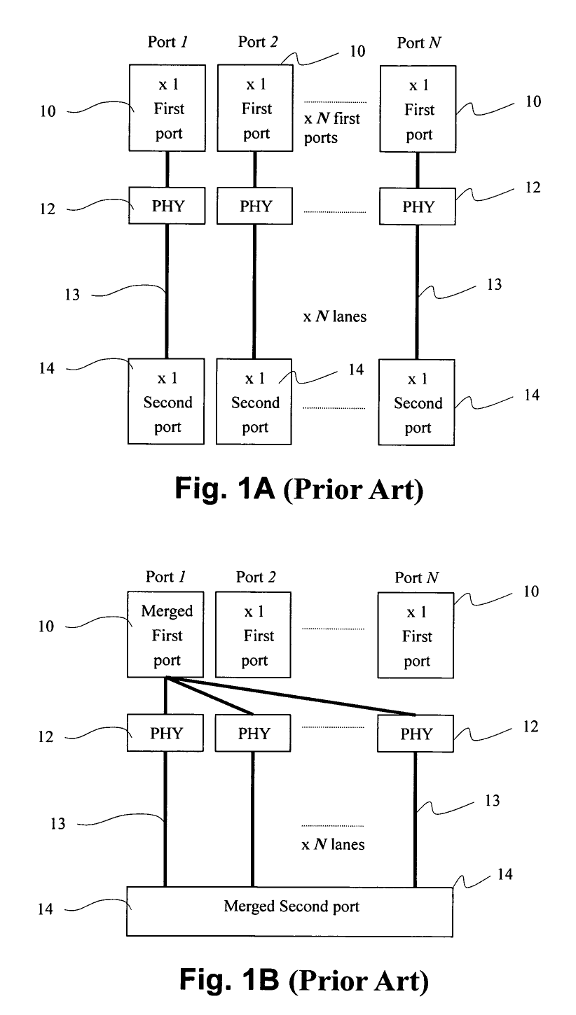

### DETAILED DESCRIPTION

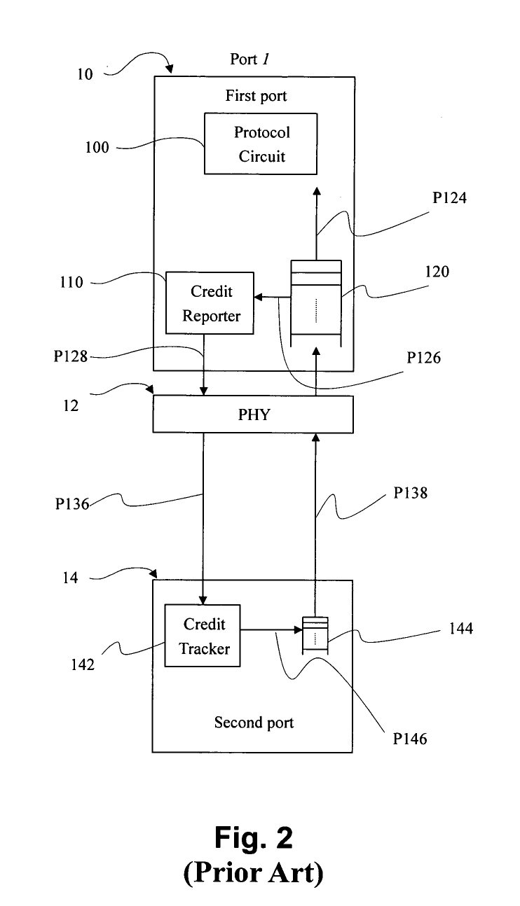

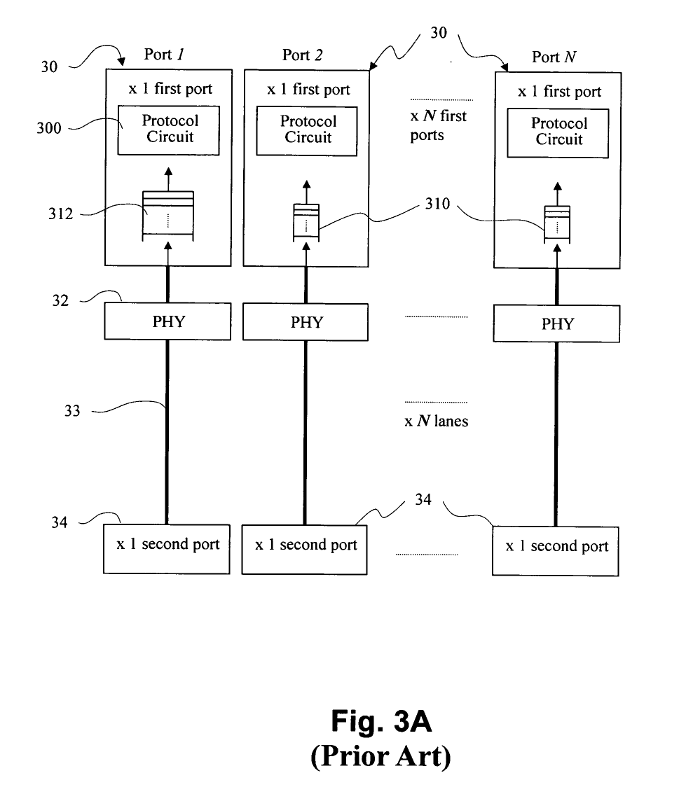

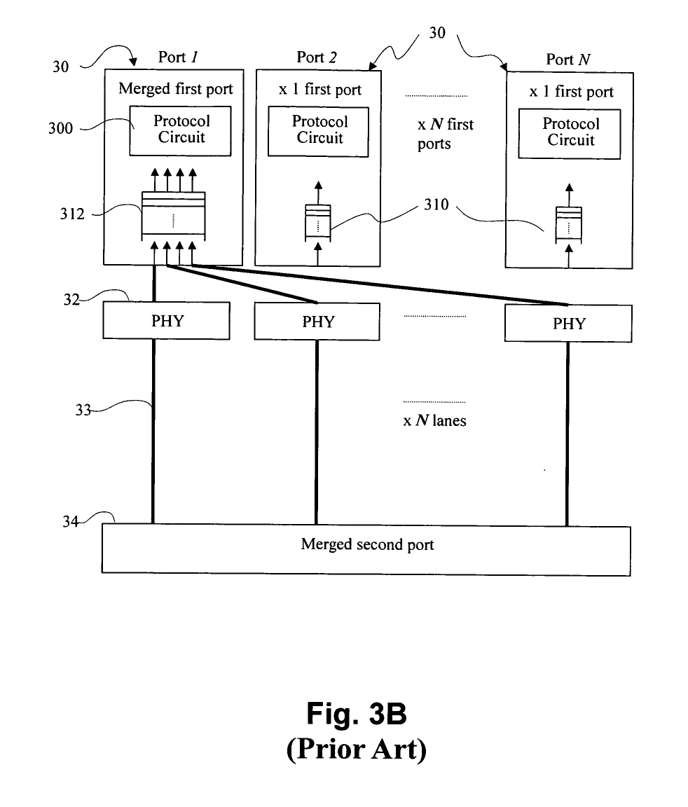

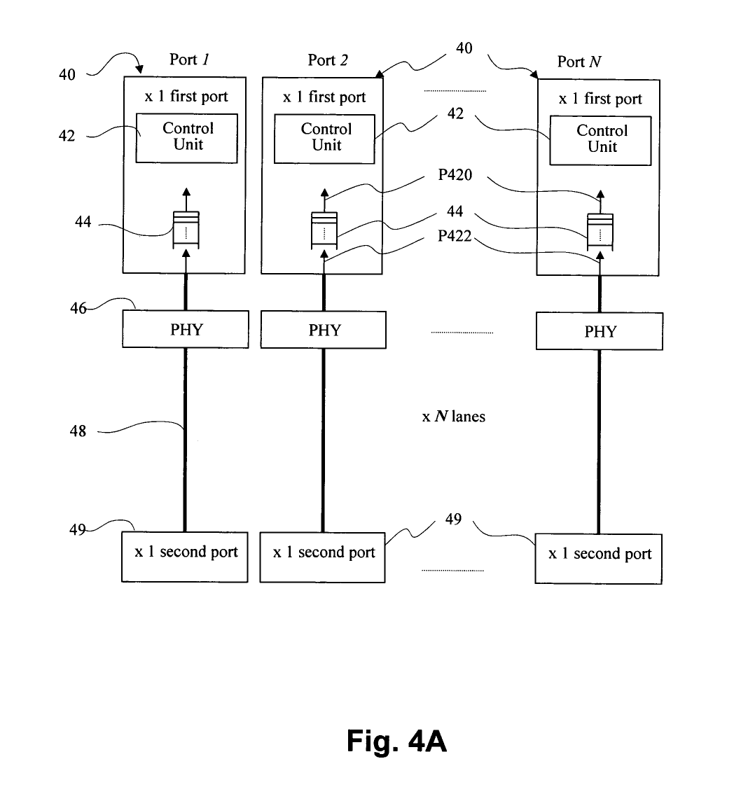

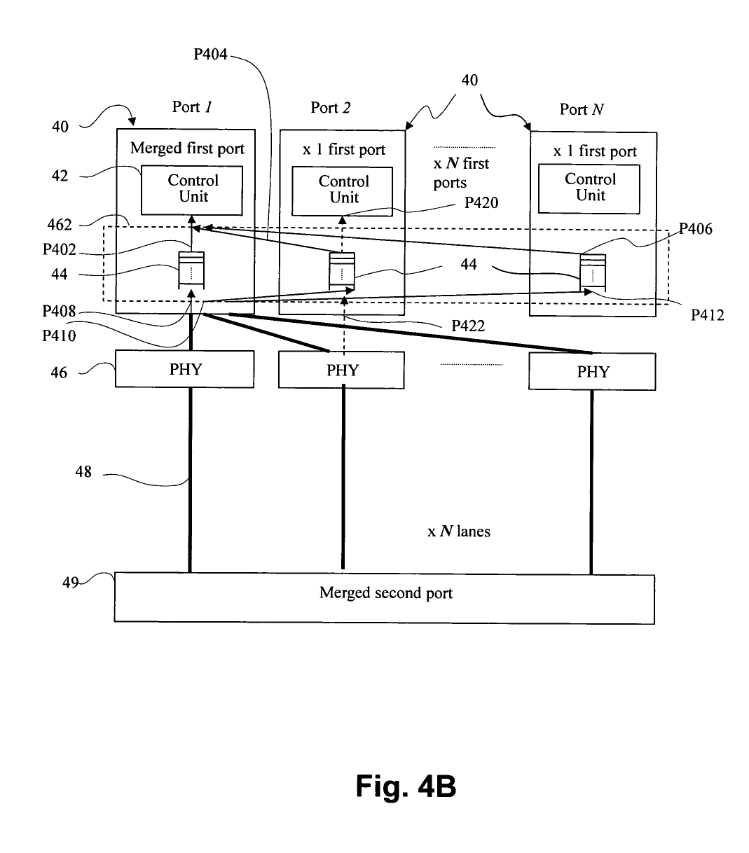

Please referring to FIGS. 4A & 4B, a plurality of first and second remote ports 40, 49 of a computerized system, according to a first preferred embodiment of the present invention, respectively implement data transactions with each other via a physical layer (PHY) 46 and a transmission line 48. Each of the first ports 40 has a credit reporter (not shown), a first receiving buffer (RB) 44, and a flow controlling unit 42 disposed within each of the plurality of first ports 40 to control each corresponding receiving buffer 44. Each of the second reports 49 has a credit tracker and a second receiving buffer both as shown in FIG. 2.

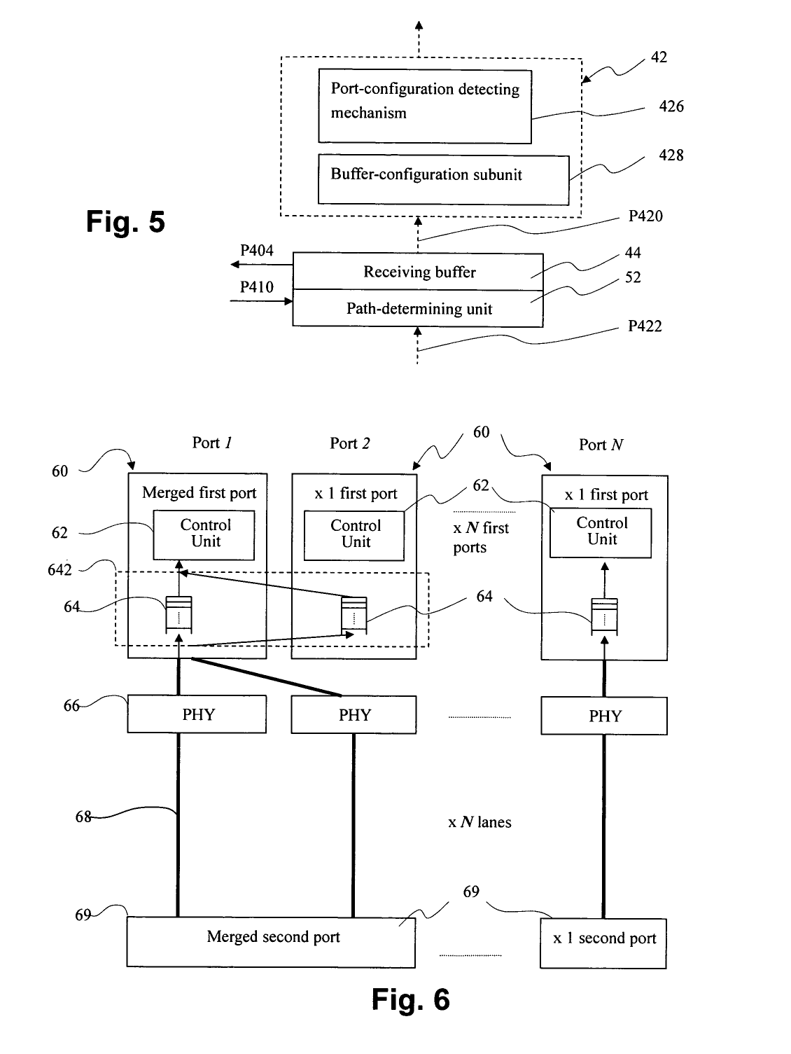

Further referring to FIG. 5, the flow controlling unit 42 further includes a port-configuration detecting mechanism 426 and a buffer-configuration subunit 428. Meanwhile, the port-configuration detecting mechanism 426 is used to inspect configuration status of all of the first ports 40 on variance of data transmission bandwidths, e.g. “merge” or “spilt” status. The detecting mechanism 426 may be trigged by a register generated for configuration status of the first port with bandwidth variances. According to the present invention, the flow controlling unit 42 is capable of being implemented in either a software or hardware type.

The buffer-configuration subunit 428, upon either “split” or “merge” configuration status of each first port 40, decides configuration of each of the corresponding first receiving buffers 44 as shown in FIG. 4A or 4B.

As “split” status shown in FIG. 4A, each of the first ports 40, e.g. a port 2, is configured with individual bandwidth, functioning as the same as the prior art, that its flow controlling unit 42 enacts the credit report (not shown) to periodically receive a credit message covering empty part of only one receiving buffer 44 individually owned by the first port (2) 40 and then to periodically report the credit message to the corresponding second port 49. As long as the second port 49 receives the credit message regarding the first receiving buffer 44 of the first port (2) 40, the credit tracker of the second report 49 would determine whether the credit is larger than size of a data that the second port 49 would like to send, or not. If the credit exactly is larger than size of the data, the credit tracker of the second port 49 will request the second receiving buffer (not shown) to send the data to first port (2) 40 with regard to the checked credit (the step is referred to a numeral P422 illustrated in FIG. 4A). The data send to the first port (2) 40 will be stored within the first receiving buffer 44 for data consumption of the first port (2) 40 (the step is referred to a numeral P420 illustrated in FIG. 4A). In contract, as long as finding that the credit is less than size of the data, the credit tracker of the second port 49 will temporarily disable sending of the data from the second receiving buffer to the first port (1) 40 until a next credit is larger than size of the data.

As “merge” status shown in FIG. 4B, a specific first port (1) 40 is initially reconfigured with merges of multiple bandwidths of the other first ports (2˜N) 40. Then the buffer-configuration subunit 428, upon said “merge” consideration status of the first ports (1˜N) 40, configures the first receiving buffer 44 owned by the specific first port 1 and the first receiving buffers 44 owned but disused by the other first ports (2˜N) 40 to constitute a buffer group 462 with merging of storing spaces of all of the configured first receiving buffers 44.

Beside, the buffer-configuration subunit 428 further enact the credit reporter of the specific first port (1) 40 to periodically receive a credit covering empty part of all of the merged storing spaces of the buffer group 462 and then to periodically report the credit to the corresponding second port 49. While the second port 49 receive the credit of the buffer group 462 therein, the credit tracker of the second port 49 will determine whether the credit is larger than size of a data that the second port 49 would like to send, or not. As long as finding that the credit is larger than size of the data, the credit tracker of the second port 49 will inform the second receiving buffer of sending the data stored within the second receiving buffer to the first receiving buffer 44 of the specific first port (1) 40. Thereafter, the credit recorded in the credit tracker of the second port 14 is newly updated with subtraction of size of the data that was send to the specific first port (1) 40 for continuous tracking. After the data send to the specific first port (1) 40 is sequentially stored within the merged storing space of buffer group 462 used by the specific first port (1) 40 (the steps are referred to the numerals P408, P410 & P412 illustrated in FIG. 4B). In a proper period, the buffer-configuration subunit 428 further enacts the specific first port (1) 40 to sequentially consume the data from the merged storing space of the buffer group 462 (the steps are referred to the numerals P402, P404 & P406 illustrated in FIG. 4B). In contract, as long as finding that the credit is less than size of the data, the credit tracker of the second port 49 will temporarily disable sending of the data from the second receiving buffer to the specific first port (1) 40 until a next credit is larger than size of the data.

According to the present invention, the buffer-configuration subunit 428 can further includes a protocol circuit that is enacted by the subunit 428 to configure the receiving buffers of the specific first port 40 and the other first ports 40 to constitute the buffer group 462.

However, to switch different data-transmission path upon different configuration status of each first port 40, a path-determining unit 52, e.g. a multiplexer (MUX), can be disposed on a data entry of the first receiving buffer 44 of each first port (1˜N) 40 as shown in FIG. 5. For example, a path-determining unit (not shown) located within the other first port (2) 40 as shown in FIG. 4A is enacted by the buffer-configuration subunit 428 of the first port (2) 40 configured with individual bandwidth to directly receive the data from the first port (2) 40 to the first receiving buffer 44 of the other first port (2) 40 for data consumption of the first port (2) 40 (the steps are referred to the numerals P422 & P420). Oppositely, the path-determining unit (not shown) of the other first port (2) 40 shown in FIG. 4B is enacted by the buffer-configuration subunit 428 of the specific first port (1) 40 configured with merging of storing spaces of the other first ports (2˜N) to receive the data from the specific first port (1) 40 to the first receiving buffer 44 of the other first port (2) 40 included within a merged storing space of a buffer group 462 for data consumption of the specific first port (1) 40 (the steps are referred to the numerals P408, P410 & P404).

Further referring to FIG. 6, a plurality of first ports (1˜N) 60 according to a second preferred embodiment of the present invention are reconfigured into a first port (1) 60 with merging of multi-bandwidths of the other first port (2) 60, and a first port (N) 60 with individual bandwidth. Based on the same theory as aforementioned first preferred embodiment, a flow controlling unit 62 of the first port (1) 60 would reconfigure the receiving buffer 64 owned the first port (1) 60 and the receiving buffer 64 owned but disused by the first port (2) 60 to constitute a different reconfigured buffer group 642 with different sizes of merged storing spaces. Differently, the flow controlling unit 62 of the first port (N) 60 reconfigured with individual bandwidth remains on controlling only one an individual receiving buffer 64.

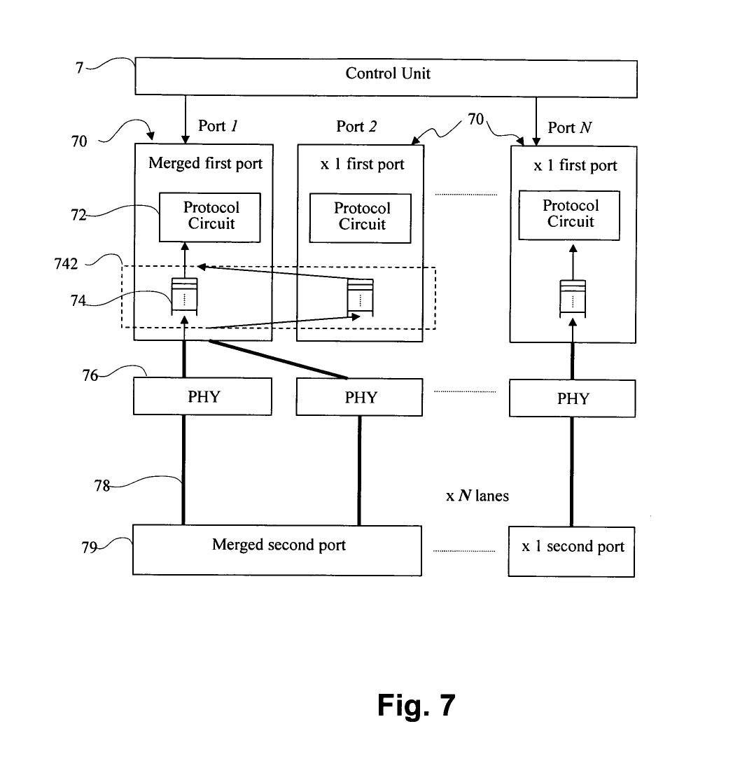

Further referring to FIG. 7, a plurality of first ports (1˜N) 70 according to a third preferred embodiment of the present invention are reconfigured into a first port (1) 70 with merging of bandwidth of the other first port (2) 70, and a first port (N) 70 with individual bandwidth. There is only one difference between the second and third embodiments that a flow controlling unit 7 of the third embodiment is disposed out of each first port 70 to enact a protocol circuit 72 for configuration of receiving buffers 74 into a buffer group 742.

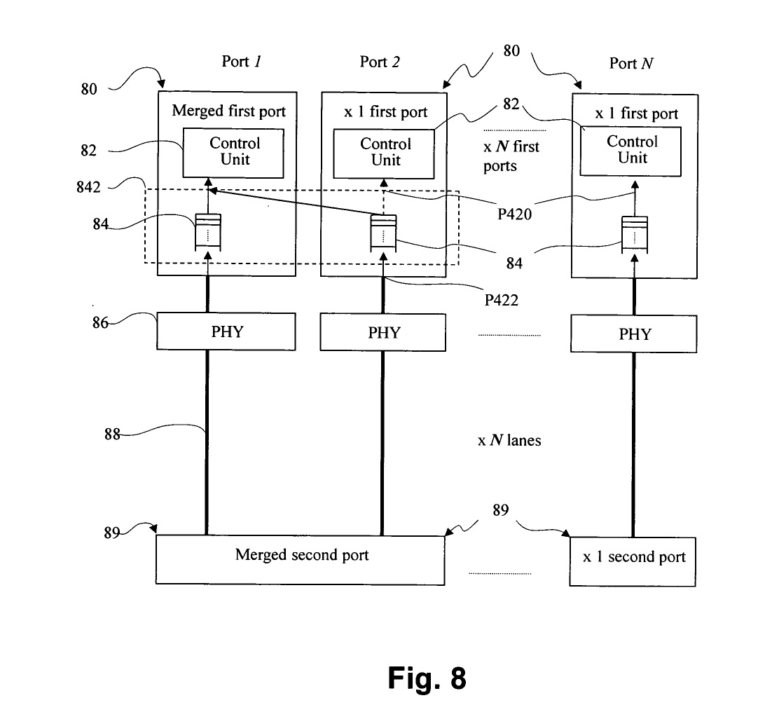

Further referring to FIG. 8, a plurality of first ports (1˜N) 80 according to a fourth preferred embodiment of the present invention are reconfigured into a first port (1) 80 with merging of bandwidth of the other first port (2) 80, and a first port (N) 80 with individual bandwidth. There is only one difference between the second and fourth embodiments that all of data-transmission paths from a second port 89 to the receiving buffer 84 of the merged-bandwidth first port (2) 80 can be modified to be directly connected with the receiving buffer 84 of the first port (2) 80 (the step is referred to a numeral P422), rather than through the specific first port (1) 80 by way of usage of a path-determining unit 52 shown in FIG. 5. Also, such data-transmission path may provide a credit reporter of the first port (2) 80 with directly transmitting a credit message covering empty part of the receiving buffer 84 of the first port (2) 80 to the second port 89, rather than through a credit reporter of the specific first port (1) 80.

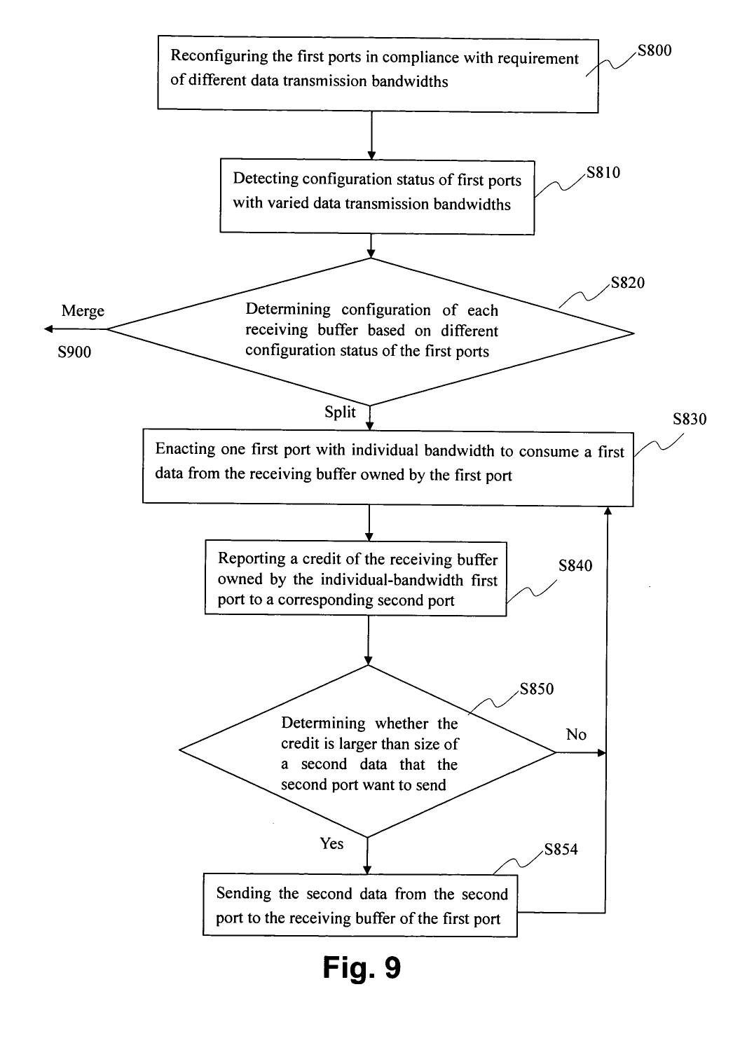

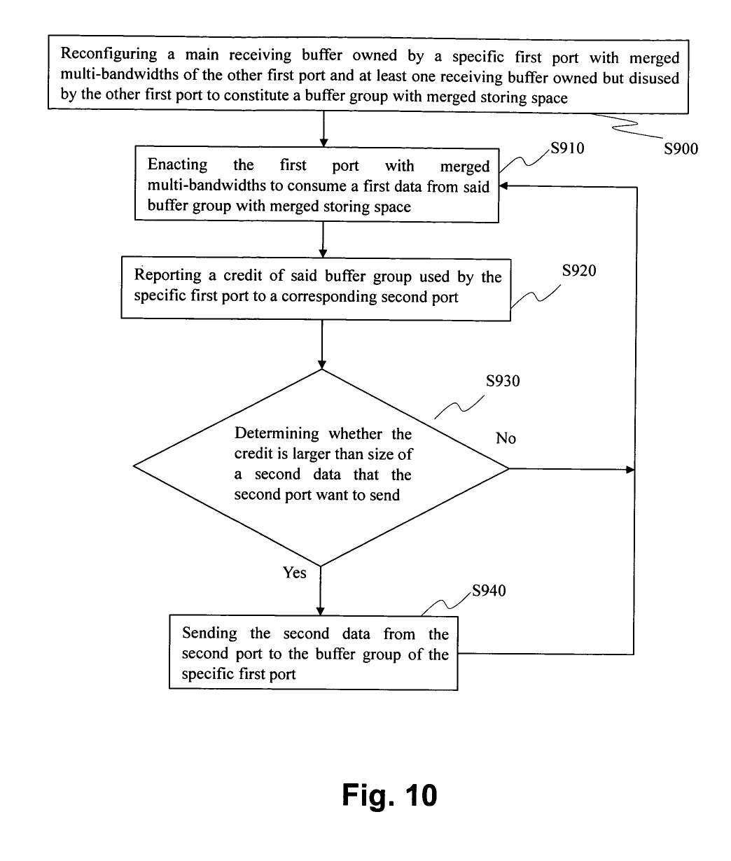

Beside, a method for performing an optimum flow control between a plurality of first and second ports of a computerized system is presented in FIGS. 9 & 10, according to the present invention. The method comprises the following steps:

In step S800, reconfiguring all of the first ports in compliance with requirement of different data transmission bandwidths;

In step S810, detecting a current configuration status of the first ports with variance of data-transmission bandwidths, e.g. “split” or “merge” status;

In step S820, determining configuration of each of the receiving buffers based on different configuration status of the first ports. If the first port is configured on “split” status, the following implementation enters the step S830; otherwise on the ”merge” status, the following implementation enters the step S900;

In step S830, enacting one first port with individual bandwidth to consume a first data from the receiving buffer owned by the first port if the first port is configured on “split” status;

In step S840, periodically reporting a credit message covering empty part of the receiving buffer owned by the individual-bandwidth first port to a corresponding second port;

In step S850, determining whether the credit is larger than size of a second data that the second port would like to send, or not after the second port receive the credit;

In step S854, sending the second data from the second port to the receiving buffer of the first port if the credit is larger than size of the second data of the corresponding second port; and then returning the step S830 for data storage and consumption of the first port; Oppositely, disabling sending of the second data form second port to the first port and then also returning the step S830 if the credit is less than size of the second data of the corresponding second port;

In step S900, reconfiguring a main receiving buffer owned by a specific first port with merged multi-bandwidths of the other first port and at least one receiving buffer owned but disused by the other first port to constitute a buffer group with merged storing space;

In step S910, enacting the first port with merged multi-bandwidths to consume a first data from the merged storing space of said buffer group;

In step S920, periodically receiving a credit covering empty part of all of the merged storing space of said buffer group used by the specific first port and then periodically reporting the credit to the corresponding second port; In step S930, determining whether the credit is larger than size of a second data that the second port would like to send or not after the second port receives the credit; and

In step S940, sending the second data from the second port to the merged storing space of said buffer group used by the specific first port if the credit is larger than size of the second data of the corresponding second port; and then returning the step S910 for data storage and consumption of the specific first port; Oppositely, disabling sending of the second data form second port to the buffer group and then also returning the step S910 if the credit is less than size of the second data from the corresponding second port.

In conclusion, data transmission ports with flow controlling unit according to the present invention, can reconfigure a receiving buffer owned by the specific first port and the receiving buffers owned but disused by other first ports into a buffer group with merging of storing spaces of said reconfigured receiving buffers upon a “merge” configuration status of the above-mentioned first ports with merging of multi bandwidths. Therefore, the invention is capable of providing an optimum and flexible flow-control service during data transaction, without need of enlarging any one receiving buffer with hardware-cost increase, in compliance with requirement of different configuration status of data-transmission port with variance of bandwidth.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for performing flow control between a plurality of first ports and at least a second port wherein each of the first ports owns a corresponding buffer, comprising the steps of:
configuring at least a specific first port to merge bandwidth of the other first port;
controlling a buffer of the specific first port and a buffer owned but disused by the other first port to constitute a buffer group which merges all of storing spaces of the controlled buffers, according to configuration status of said merging-bandwidth first ports;
reporting a credit covering empty part of the merged storing space of the buffer group to a corresponding second port; and
sending a data from the corresponding second port to be stored within the merged storing space of the buffer group, according to said credit.

2. The method as described in claim 1, further comprising of the step: detecting configurations status of all of the first ports on variances of data-transmission bandwidth.

3. The method as described in claim 1, further comprising of the step: determining configuration of each said buffer based on different configuration status of the first ports to facilitate control of the relative buffer.

4. The method as described in claim 1, further comprising of the step: reconfiguring the buffer of the specific first port and the buffer owned but disused by the other first port to constitute a reconfigurable buffer group which merges all of the storing spaces of the reconfigured buffers, according to different reconfiguration status of said first ports.

5. The method as described in claim 1, wherein the specific first port further comprises a credit reporter that periodically receives the credit covering empty part of the merged storing space of the buffer group and then reports the credit to the corresponding second port.

6. The method as described in claim 1, wherein each of the merging-bandwidth first ports further comprises a credit reporter that periodically receives the credit covering empty part of a storing space of the buffer owned by itself and then reports the credit to the corresponding second port.

7. The method as described in claim 1, further comprising of the step: determining whether the credit is larger than size of the data that the corresponding second port wants to send, as long as the corresponding second port receive the credit.

8. The method as described in claim 7, further comprising of the step: sending the data from the second port to be stored within the merged storing space of the buffer group as soon as the credit is larger than size of the data.

9. The method as described in claim 8, wherein the corresponding second port comprises a credit tracker used to receive said credit covering empty part of the merged storing space of the buffer group for comparison with the size of the data.

10. The method as described in claim 8, wherein the corresponding second port comprises a credit tracker that respectively receives said credits covering empty part of the merged storing space of the buffer of each of the merging-bandwidth first ports for comparison with the size of the data.

11. The method as described in claim 8, further comprising the step of: sending the data from the second port to be stored within the merged storing space of the buffer group via the specific first port as soon as the credit is larger than size of the data.

12. The method as described in claim 8, further comprising the step of: updating the credit with subtraction of the size of the data that is ready to be send to the merged storing space of the buffer group.

13. The method as described in claim 8, further comprising the step of: sending the data from the second port to be stored within the merged storing space of the buffer group via each of the merging-bandwidth first ports as soon as the credit is larger than the size of the second data.

14. The method as described in claim 13, wherein each of the merging-bandwidth first ports further comprises a path-determining unit disposed on data entry of the buffer owned by itself thereby determining different data-transmission paths in accordance with different configuration status of the merging-bandwidth first ports.

15. The method as described in claim 1, further comprising the step of: enacting the specific first port to consume the data from the merged storing space of the buffer group.

16. A method for performing flow control between a plurality of first ports and at least a second port wherein each of the first ports owns a corresponding buffer, comprising the steps of:
configuring at least a specific first port to merge bandwidth of the other first port;
controlling a buffer of the specific first port and an adjacent buffer owned but disused by the other first port to constitute a buffer group which merges all of storing spaces of the controlled buffers, according to configuration status of said merging-bandwidth first ports;
determining whether a credit that covers empty part of said the merged storing space of the buffer group is larger than size of a data that the corresponding second port want to send or not; and
sending the data from the second port to be stored within the merged storing space of the buffer group used by the specific first port as soon as the credit is larger than size of the data.

17. The method as described in claim 16, further comprising the step of: periodically reporting the credit to the corresponding second port for further comparison with size of the data from the corresponding second port.

18. The method as described in claim 16, further comprising the step of: enacting the specific first port to consume the data from the merged storing space of the buffer group.

19. The method as described in claim 16, further comprising the step of: disabling sending of the data from the second port to be stored within the merged storing space of the buffer group used by the specific first port as soon as the credit is less than size of the data.

20. A method for performing flow control between a plurality of first ports and at least a second port wherein each of the first ports owns a corresponding buffer, comprising the steps of:
configuring at least a specific first port to merge bandwidth of the other first port;
configuring a buffer of the specific first port and an buffer owned but disused by the other first port to constitute a buffer group which merges all of storing spaces of the configured buffers, according to configuration status of said merging-bandwidth first ports;
sending a data from the second port to be stored within the merged storing space of the buffer group, according to a credit that covers empty part of the merged storing space of the buffer group; and
enacting the specific first port to consume the data from the merged storing space of the buffer group.

21. The method as described in claim 20, further comprising the step of: reporting the credit covering empty part of the merged storing space of the buffer group to the corresponding second port.

22. The method as described in claim 21, further comprising of the step: determining whether the credit is larger than size of the data that the corresponding second port want to send, as long as the corresponding second port receive the credit.

23. The method as described in claim 22, further comprising of the step: sending the data from the second port to be stored within the merged storing space of the buffer group via the specific first port as soon as the credit is larger than size of the data.

24. The method as described in claim 22, further comprising of the step: sending the data from the second port to be stored within the merged storing space of the buffer group via each of the merging-bandwidth first ports as soon as the credit is larger than size of the data.

25. A method for performing flow control between a plurality of first ports and at least a second port wherein each of the first ports owns a corresponding receiving buffer, comprising the steps of:
enacting a specific first port to consume a data from a merged storing space covering the receiving buffers of the specific first port and the other first port after the specific first port is configured on merging bandwidth of the other first port; and
enacting the specific first port to consume a data from the receiving buffer owned by the specific first port after the specific first port is configured with individual bandwidth.

26. A method for performing flow control between a plurality of first ports and at least a second port wherein each of the first ports owns a corresponding receiving buffer, comprising the steps of:
sending a data from a second port to a merged storing space covering the receiving buffers of a specific first port and the other first port after the specific first port is configured on merging bandwidth of the other first port; and
sending a data from the second port to the receiving buffer owned by the other first port after the other first port is configured with individual bandwidth.

27. The method as described in claim 26, further comprising of the step: determining a data transmission path to the receiving buffer of each first port upon different configuration status of all of the first ports on variance of bandwidths.

28. The method as described in claim 27, further comprising of the step: enacting a path-determining unit disposed on a data entry of each of the first ports to determine a data transmission path from either the specific first port or the other first port.

29. A flow controlling unit implemented for a plurality of first ports each with a receiving buffer and at least one second port, comprising:
a port-configuration detecting mechanism inspecting configurations status of the first ports on variance of data-transmission bandwidths;
a buffer-configuration subunit, upon configurations status of at least a specific first port with merging of bandwidth of the other first port, configuring the receiving buffers of the specific first port and the other first port to constitute a buffer group with merging of storing spaces of the configured receiving buffers of which a credit is reported to a corresponding second port to determine sending back of a data from the second port as soon as the credit is larger than size of the data.

30. The controlling unit as described in claim 29 wherein the port-configuration detecting mechanism inspects a register generated for different configuration status of the first port with bandwidth variances.

31. The controlling unit as described in claim 29 wherein the controlling unit is capable of being implemented in either a software or hardware type.

32. The controlling unit as described in claim 29 wherein the buffer-configuration subunit further enacts a protocol circuit on controlling the receiving buffers of the specific first port and the other first port to constitute the buffer group.

33. The controlling unit as described in claim 29 wherein the buffer-configuration subunit further enacts a credit reporter disposed within the specific first port to report the credit covering empty part of merged storing spaces of the buffer group to the corresponding second port.

34. The controlling unit as described in claim 29 wherein the buffer-configuration subunit further enacts a credit reporter disposed within each of the merging-bandwidth first ports to report the credit covering empty part of a storing spaces of the buffer owned by the merging-bandwidth first port to the corresponding second port.

35. The controlling unit as described in claim 29 wherein the buffer-configuration subunit further enacts the specific first port to consume the data from the merged storing space covering the receiving buffers of the specific first port and the other first port after the specific first port is configured on merging bandwidth of the other first port.

36. The controlling unit as described in claim 29 wherein the buffer-configuration subunit further enacts a path-determining unit on receiving the data from either the specific first port or the other first port to store the data within the receiving buffer of the other first port.

37. The controlling unit as described in claim 36 wherein the path-determining unit is disposed on a data entry of the receiving buffer of each first port.

38. The controlling unit as described in claim 37 wherein the path-determining unit is a multiplexer.
